(19) United States
(12) Patent Application Publication
(10) Pub. No.: US 2004/0007557 A1
(43) Pub. Date: Jan. 15, 2004

(54) Wine bottle label memento

(76) Inventors: Diane Shea Maliszewski, San Diego, CA (US); Chester Paul Maliszewski, Buffalo, NY (US); Christine Blubaugh Mersten, San Diego, CA (US); Gerald William Maliszewski, San Diego, CA (US)

Correspondence Address: LAW OFFICE OF GERALD MALISZEWSKI, P.O. BOX 270829, SAN DIEGO, CA, 92198-2829, US

(21) Appl. No.: 10/192,375

(22) Filed: Jul. 10, 2002

(51) Int. Cl. B65C 3/26

(52) U.S. Cl. 215/365; 156/277; 40/638; 215/386

(57) ABSTRACT

A system and method are provided for a product memento that is detachable from a product such as a bottle. The memento provides a convenient means of saving and storing product information that helps the user find and purchase an equivalent bottle of the desired product at a later date. The bottle memento system comprises a wine bottle (for example), a label affixed to the wine bottle, and a detachable memento affixed overlying the wine bottle. The memento is used to identify the wine bottle. In some aspects the memento is a detachable portion of the label. In other aspects, the memento is affixed directly to the bottle as an auxiliary label. The memento can include such information as the vintager, vintage, type of wine, type of grape, growing region, location of vintager, awards, price, barcode, reviews, coupons, or distributor.

### BACKGROUND OF THE INVENTION

1. Field of the Invention

This invention generally relates to product marking and identification and, more particularly, to a system and method for creating a memento to remember a packaged product, or packaged product label.

2. Description of the Related Art

How many times have you gone to a restaurant and enjoyed a good bottle of wine whose name you couldn't remember the next day (regardless of how many glasses you had)? Perhaps it was a wine not featured in the local shops you frequent, or perhaps it was made from a type of grape unfamiliar to you. To make things worse, many good wines have pesky foreign names that are so hard to remember or even pronounce.

It is possible to take the bottle home with you, but walking out of a restaurant with an empty bottle can be embarrassing. Further, the empty bottle can be difficult to explain to the Highway Patrol if you are stopped on the way home. It is possible to remove the label. However, scrapping the label from the bottle rarely works, and soaking the label off requires cooperation from the waiter, and so increases the size of the expected tip. Further, what does one do with a wet label? Critical information can be copied from the label. However, even if a pen (or eyebrow liner pencil) can be found, one must still find a decent piece of paper, or remember to transcribe the information from their palm before washing.

It would be advantageous if there were an easy way to remember the critical information from a product, such as a wine bottle, to enable one to purchase the same type of product at a later date.

It would be advantageous if a wine bottle included a memento with some of the information from the wine bottle label.

### SUMMARY OF THE INVENTION

A system and method are provided for a package memento that is detachable from a packaged product such as a bottle of wine. The memento provides a convenient means of saving and storing product information that helps the user find and purchase an equivalent bottle of the desired product at a later date.

Accordingly, a product memento system is provided that comprises a wine bottle (for example), a label affixed to the wine bottle, and a detachable memento affixed overlying the wine bottle. The memento is used to identify the wine bottle. In some aspects the memento is a detachable portion of the label. In other aspects, the memento is affixed directly to the bottle as an auxiliary label. Alternately, the memento can be a tag. The memento can include such information as the vintager, vintage, type of wine, type of grape, growing region, location of vintager, awards, price, barcode, reviews, coupons, or distributor.

Additional details of the system, a memento, and a method for remembering information from a wine bottle label are provided below.

### BRIEF DESCRIPTION OF THE DRAWINGS

FIG. 1 is a perspective view of the present invention product memento system.

FIG. 2 is a more detailed depiction of the label and memento of FIG. 1.

FIG. 3 is a partial cross-sectional view of another variation of the label and memento of FIGS. 1 and 2.

FIG. 4 is a perspective view featuring a variation of the present invention product memento system.

FIG. 5 is a perspective drawing illustrating details of the memento depicted in FIG. 4.

FIGS. 6a through 6c are perspective views featuring the present invention bottle memento tag variation.

FIG. 7 is a flowchart illustrating the present invention method for memorializing a product label.

### DETAILED DESCRIPTION OF THE PREFERRED EMBODIMENTS

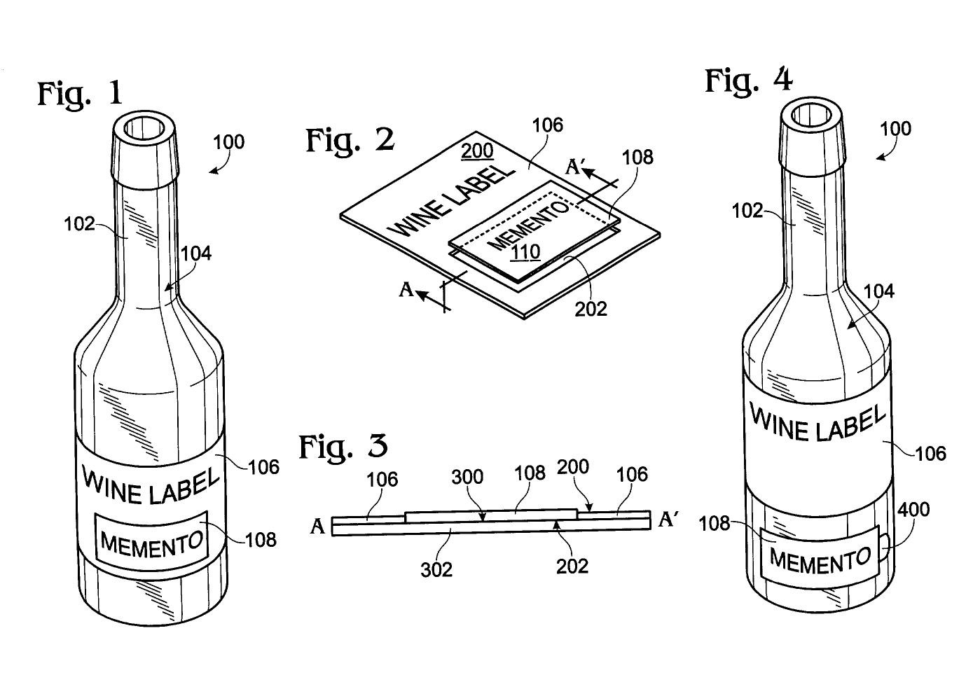

FIG. 1 is a perspective view of the present invention product memento system. The system 100 comprises a product 102 having an exterior surface 104. The product can be a bottle or a can for example, but the invention is not limited to any particular product type, material, or shape. However, for simplicity, the product will be described hereafter as a bottle. The bottle 102 can be a wine bottle for example, however, the present invention system can also be used to memorialize other types of bottled products such as water or condiments. A label 106, having an interior surface (not shown), is affixed to the exterior surface 104 of the bottle 102. A detachable memento 108 has an interior surface (not shown) affixed overlying the exterior surface 104 of the bottle 102. The memento 108 is used to identify, remember, or memorialize the bottle 102. More specifically, the memento 108 is used to identify the label 106, which in turn permits a user to identify a specific type of bottled product. As shown, the memento 108 is a detachable portion of the label 106.

FIG. 2 is a more detailed depiction of the label 106 and memento 108 of FIG. 1. The memento 108 has an exterior surface 110 with markings such as vintager, vintage, type of wine, type of grape, growing region, location of vintager, awards, price, barcode, reviews, and/or distributor. The memento can also act as a form of coupon. For example, a coupon permitting the coupon holder to purchase a similar product at a reduced rate. When the product is other than wine, more generic identifying markings such as manufacturer, lot number, sales promotion information, or the product name can be included on the memento surface. In other aspects, the memento exterior surface 110 is completely or partially blank so that the customer, distributor, vintager, restaurateur, or retailer can add information to the memento.

The label 106 has an exterior surface 200. The memento 108 interior surface (not shown) is affixed to the exterior surface 200 of the label 106. In some aspects of the system, an adhesive (not shown) is attached to the memento interior surface. This adhesive is used to adhere the memento 108 to the label 106, until detached. Alternately, the adhesive is attached to the label exterior surface 200, in area 202, underlying the memento interior surface.

There are many conventional label-attaching adhesives that can be used to adhere the memento 108 to the label 106 in a detachable way. In some aspects, both the label 106 and the memento 108 are paper. In other aspects, the memento 108 is a metallic foil. The adhesive initially attached to the memento 108, or the residue adhesive remaining on the memento 108 can be used to adhere the memento 108 to a sheet of notebook paper (not shown), for example, when detached from the label. Alternately, no adhesive residue remains on the memento interior surface, so that the memento 108 can be stored in a wallet (not shown), for example, without sticking to other items in the wallet.

FIG. 3 is a partial cross-sectional view of another variation of the label 106 and memento 108 of FIGS. 1 and 2. In this aspect, attachment area 202 of the label surface is glossy or relatively slick, so that a paper memento interior surface 300 can be easily removed without sticking to the label 106. The glossy area may be part of a layer 302 completely underlying the label 106, as shown. In other aspects not shown, the glossy area may be limited to just the area 202 underlying the memento 108. In these aspects, the memento 108 would resemble a conventional peel-off return address label or address label of the type that is stuck to an envelope after peeling. The detached memento 108 remains adhesive, to stick in a notebook or day planner for example (not shown), in some aspects. Alternately, the detached memento 108 is not sticky.

With respect to FIGS. 2 and 3, in some aspects of the system, the label 106 and memento 108 are the same. That is, the entire label 106, or at least the part of the label 106 including the significant information, can be removed as the memento 108. Alternately, the label 106 and memento 108 are formed from a common sheet of paper that can be torn into separate memento 108 and label 106 sections. In some aspects, a starter string (not shown), underlying the label 106, is pulled to split the memento 108 from the portion of the label 106 remaining affixed to the bottle.

FIG. 4 is a perspective view featuring a variation of the present invention product memento system 100. The memento 108 is not attached to the label 106, but is directly affixed to the bottle exterior surface 104. An adhesive can be attached to the memento interior surface (not shown), or to the bottle exterior surface 104 underlying the memento interior surface. As above, the memento 108 can be paper or metallic foil, to name but a few conventional label materials. The adhesive initially attached to the memento 108, or the residue adhesive remaining on the memento 108, can be used to reattach the memento 108 to another sheet of paper (not shown), for example. Alternately, in other aspects, minimal adhesive residue remains on the memento interior surface, so that the memento 108 can be stored in a wallet, pocket, or purse (not shown) for example.

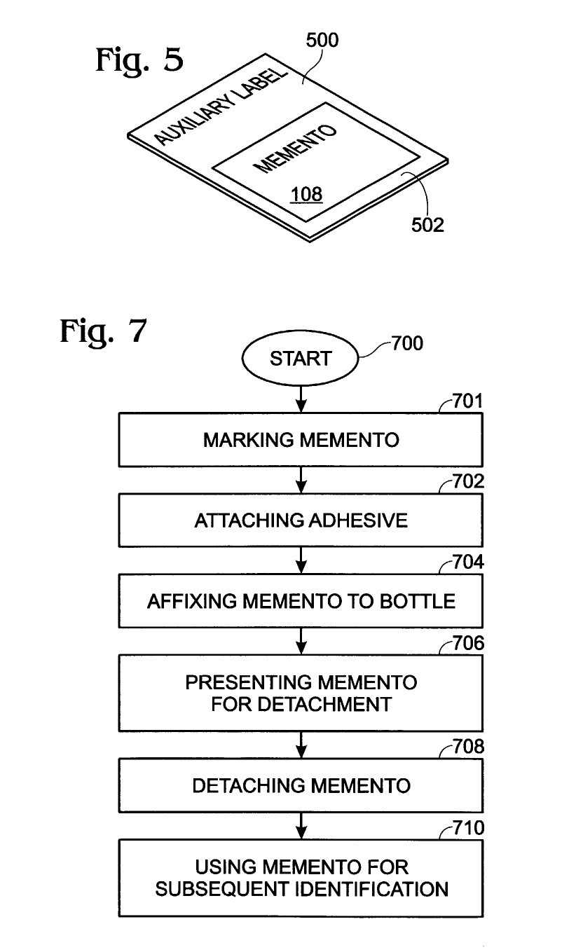

FIG. 5 is a perspective drawing illustrating details of the memento 108 depicted in FIG. 4. This variation includes an auxiliary label 500 having an interior surface (not shown), affixed overlying the exterior surface of the bottle (see FIG. 4). The auxiliary label 500 has an exterior surface 502. The memento interior surface (not shown) is affixed to the exterior surface 502 of the auxiliary label 500. This variation of the invention permits the label design to remain independent of the memento. In this manner a famous, well-recognized label design need not be changed, even when a memento auxiliary label 500 is added to the bottle. Further, an independent auxiliary label permits the auxiliary label memento to be selectively added. For example, the auxiliary label memento can be added to only the bottles shipped to the United States. Additionally, an auxiliary label memento can be added after shipment from the manufacturer, by a distributor for example.

As above, the auxiliary label 500 and the memento 108 can both be paper, or the memento 108 can be a metallic foil overlying a label of either paper or foil. In other aspects, the auxiliary label 500 includes a glossy attachment area such as shown in FIG. 3 and described above.

Returning to FIG. 4, in some aspects of the system 100, the memento 108 includes a pull-tab handle 400 to grasp when detaching the memento 108 from the wine bottle 102. Note that the pull-tab can also be used in the other variations of the inventions depicted in FIGS. 1, 2, 3, and 5. The memento 108 can be detached by using the pull-tab to pull the memento 108 from the bottle 102 (FIG. 4), from the auxiliary label as explained in the description of FIG. 5, or from the (primary) label 106 as explained in the descriptions of FIGS. 1, 2, and 3. Many convention pull-tab mechanisms are known in the art that would be applicable for use with the present invention. Other well-known detachment mechanisms (not shown) that could alternately be used to detach the memento from either the bottle or a label include perforations, rounded corners or edges, or a pull-string to tear a connecting paper bridge.

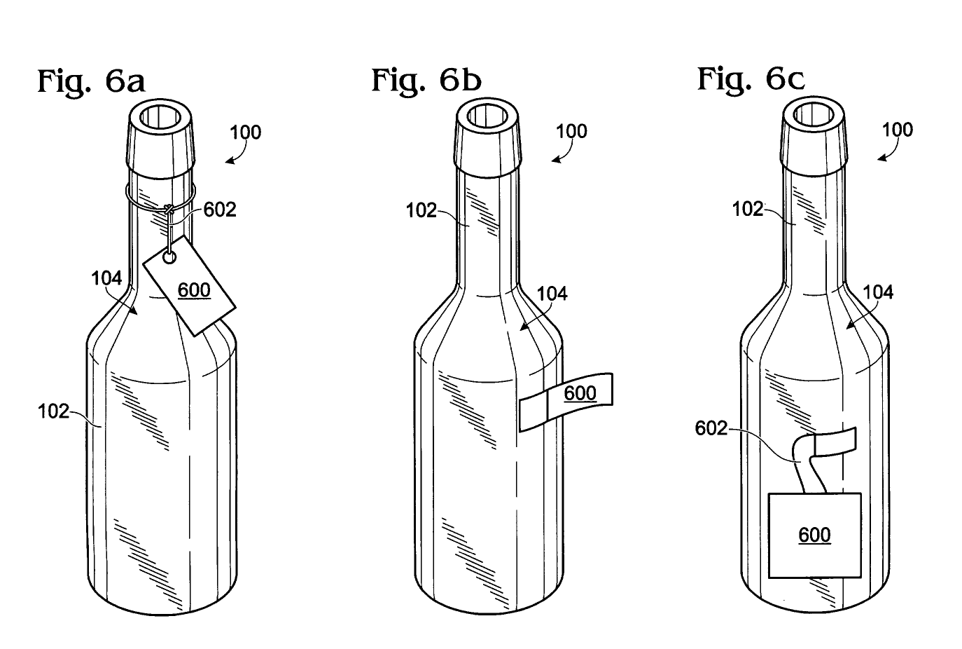

FIGS. 6a through 6c are perspective views featuring the present invention bottle memento tag variation. The memento 600 is substantially as explained above, with the difference that is a detachable memento tag. The tag material can be thin, such as paper, or semi-rigid and made from a material such as thick paper, cardboard, or plastic to name a few examples of tag materials. The invention can be enabled with any conventional tag material.

As seen in FIG. 6b, an adhesive (not shown) is used to attach at least a portion of the memento tag 600 to the bottle exterior surface 104. As above, the adhesive can be any convention adhesive, or even wax.

As seen in FIG. 6a, a link 602 has a first end attached to the tag 600 and a second end attached to the bottle exterior surface 104 neck. In FIG. 6c, the link is attached to the bottle exterior surface 104 at the body of the bottle. The link can be a string of any convention material such as hemp, fiber, or plastic, see FIG. 6b. Alternately, the link 602 can be a ribbon of cloth-like material or even paper, see FIG. 6c. The invention is not limited to any particular link material. In some aspects, the link 602 is formed from the same material as the tag.

In other aspects, the link 602 is attached to the tag through a hole in the tag, or an eyelet. The link 602 can be attached with a conventional adhesive or wax. In some aspects, the link 602 is formed as a loop that girds either the neck or body of the bottle 102. The loop can be press-fit around the bottle 102, or tied. In another aspect, the link 602 is an elastic material, like a rubber band for example, that flexibly girds the bottle 102 for attachment.

FIG. 7 is a flowchart illustrating the present invention method for memorializing a product label. This method generally corresponds to FIGS. 1 through 6c. Although the method is depicted as a sequence of numbered steps for clarity, no order should be inferred from the numbering unless explicitly stated. It should be understood that some of these steps may be skipped, performed in parallel, or performed without the requirement of maintaining a strict order of sequence. The method starts at Step 700. Step 704 affixes a memento overlying the exterior surface of a bottle. Step 706 presents the memento for detachment from the bottle. In some aspects of the method, affixing the memento in Step 704 includes affixing a label, including the memento, to the exterior surface of the bottle. Then, presenting the memento for detachment in Step 706 includes presenting the memento for detachment from the label. Step 708 detaches the memento. Step 710 uses the detached memento for subsequent identification of the bottle label.

Alternately, affixing the memento in Step 704 includes affixing the label to the exterior surface of the bottle, and affixing the memento to an exterior surface of the label. In some aspects a further step, Step 702, attaches an adhesive to an interior surface of the memento interfacing the label exterior surface. Alternately, Step 702 attaches an adhesive to the exterior surface of the label interfacing an interior surface of the label.

In some aspects of the method, affixing a memento overlying the exterior surface of a bottle in Step 704 includes attaching an adhesive to an interior surface of the memento, and affixing the memento to an exterior surface of the bottle.

In other aspects, affixing a memento overlying the exterior surface of a bottle in Step 704 includes attaching an adhesive to the exterior surface of the bottle, and affixing the memento to exterior surface of the bottle with the adhesive.

In some aspects of the method, a further step, Step 701, marks an exterior surface of the memento with markings such as manufacturer, product name, sales promotion information, and lot number. If the bottle is a wine bottle, Step 701 marks an exterior surface of the memento with markings such as the vintager, vintage, type of wine, type of grape, growing region, location of vintager, awards, price, barcode, reviews, coupons, or distributor.

In some aspects, presenting the memento for detachment from the wine bottle in Step 706 includes substeps (not shown). Step 706a forms a pull-tab handle attached to the memento. Step 706b presents the pull-tab for detaching the memento from the bottle.

In some aspects of the method where the memento is a tag, affixing the memento in Step 704 includes using adhesive to attach a least a portion of a memento tag to the exterior surface of the bottle. Alternately, Step 704 includes substeps (not shown). Step 704a attaches a link such as string, ribbon, or elastic to a semi-rigid memento tag. Step 704b attaches the link to a bottle exterior surface.

A detachable memento system and method are presented to memorialize at bottled product, or bottle label. A few examples have been given as to how the memento can be placed on a bottle. Examples have been given as to how the memento can be integrated with a label. Likewise, some examples have been given of how the memento can be detached. However, it should be understood that the invention is not limited to these examples. The invention can also be enabled using other conventional labels or labeling systems. It should also be understood that although the present invention only describes the use of a memento to identify a bottled product, the invention would also be applicable to other packages, such as cans, boxes, paper-wrapped products, and plastic-wrapped products. In another embodiment of the invention not specifically described above, the memento can be information written on a wine bottle cork. Other variations and embodiments of the invention will occur to those skilled in the art.

We claim:

1. A bottle memento system comprising:
a bottle having an exterior surface;
a label having an interior surface affixed to the exterior surface of the bottle; and,
a detachable memento having an interior surface affixed overlying the exterior surface of the bottle, to memorialize the bottle.

2. The system of claim 1 wherein the memento is a detachable portion of the label.

3. The system of claim 1 wherein the label has an exterior surface; and,
wherein the memento interior surface is affixed to the exterior surface of the label.

4. The system of claim 3 further comprising:
an adhesive attached to the memento interior surface.

5. The system of claim 3 further comprising:
an adhesive attached to the label exterior surface underlying the memento interior surface.

6. The system of claim 1 wherein the label and memento are made from paper.

7. The system of claim 1 wherein the memento is made from a metallic foil.

8. The system of claim 1 wherein the label includes a glossy attachment area; and,
wherein the memento interior surface is affixed to the label glossy attachment area.

9. The system of claim 1 further comprising:
an adhesive attached to the memento interior surface.

10. The system of claim 1 further comprising:
an adhesive attached to the bottle exterior surface underlying the memento interior surface.

11. The system of claim 1 wherein the bottle is a wine bottle; and,
wherein the memento has an exterior surface with markings selected from the group including vintager, vintage, type of wine, type of grape, growing region, location of vintager, awards, price, barcode, reviews, coupons, and distributor.

12. The system of claim 1 wherein the memento has an exterior surface with markings selected from the group including manufacturer, product name, sales promotion information, and lot number.

13. The system of claim 1 further comprising:
an auxiliary label having an interior surface, affixed overlying the exterior surface of the bottle, and an exterior surface; and,
wherein the memento interior surface is affixed to the exterior surface of the auxiliary label.

14. The system of claim 1 wherein the memento includes a pull-tab handle to grasp when detaching the memento from the bottle.

15. The system of claim 1 wherein the memento is the label; and,
wherein the label is detachable.

16. A wine bottle memento system comprising:
a wine bottle having an exterior surface;
a label having an interior surface affixed to the exterior surface of the wine bottle; and,
a detachable memento having an interior surface affixed overlying the exterior surface of the wine bottle, to memorialize the wine bottle.

17. A product memento system comprising:
a product having an exterior surface; and,
a detachable memento having an interior surface affixed overlying the exterior surface of the product, to memorialize the product.

18. A bottle memento system comprising:
bottle having an exterior surface; and,
a detachable memento tag to memorialize the bottle.

19. The system of claim 18 wherein the memento tag includes an interior surface; and;
the system further comprising:
an adhesive attaching at least a portion of the memento tag to the bottle exterior surface.

20. The system of claim 18 further comprising:
a link selected from the group including string, ribbon, and elastic having a first end attached to the tag and a second end attached to the bottle exterior surface.

21. The system of claim 18 wherein the bottle is a wine bottle; and,
wherein the memento tag has an exterior surface with markings selected from the group including vintager, vintage, type of wine, type of grape, growing region, location of vintager, awards, price, barcode, reviews, coupons, and distributor.

22. The system of claim 18 wherein the memento tag has an exterior surface with markings selected from the group including manufacturer, product name, sales promotion information, and lot number.

23. The system of claim 18 wherein the memento tag is a semi-rigid material.

24. A method for memorializing a bottle label, the method comprising:
affixing a memento overlying the exterior surface of a bottle; and,
presenting the memento for detachment from the bottle.

25. The method of claim 24 wherein affixing the memento includes affixing a label, including the memento, to the exterior surface of the bottle; and,
wherein presenting the memento for detachment includes presenting the memento for detachment from the label.

26. The method of claim 25 wherein affixing the memento includes:
affixing the label to the exterior surface of the bottle; and,
affixing the memento to an exterior surface of the label.

27. The method of claim 26 further comprising:
attaching an adhesive to an interior surface of the memento interfacing the label exterior surface.

28. The method of claim 26 further comprising:
attaching an adhesive to the exterior surface of the label interfacing an interior surface of the label.

29. The method of claim 24 wherein affixing a memento overlying the exterior surface of a bottle includes:
attaching an adhesive to an interior surface of the memento; and,
affixing the memento to an exterior surface of the bottle.

30. The method of claim 24 wherein affixing a memento overlying the exterior surface of a bottle includes:
attaching an adhesive to the exterior surface of the bottle; and,
affixing the memento to the exterior surface of the bottle with the adhesive.

31. The method of claim 24 in which the bottle is a wine bottle; and,
the method further comprising:
marking an exterior surface of the memento with markings selected from the group including vintager, vintage, type of wine, type of grape, growing region, location of vintager, awards, price, barcode, reviews, coupons, and distributor.

32. The method of claim 24 further comprising:
marking an exterior surface of the memento with markings selected from the group including manufacturer, product name, sales promotion information, and lot number.

33. The method of claim 24 further comprising:
detaching the memento; and,
using the detached memento for subsequent identification of the wine bottle label.

34. The method of claim 24 wherein presenting the memento for detachment from the wine bottle includes:
forming a pull-tab handle attached to the memento; and,
presenting the pull-tab for detaching the memento from the bottle.

35. The method of claim 24 wherein affixing the memento includes using adhesive to attach a least a portion of a memento tag to the exterior surface of the bottle.

36. The method of claim 24 wherein affixing the memento includes;
attaching a link selected from the group including string, ribbon, and elastic to a semi-rigid memento tag; and,
attaching the link to a bottle exterior surface.

37. The method of claim 24 wherein affixing the memento includes affixing an auxiliary label, including the memento, to the exterior surface of the bottle; and,
wherein presenting the memento for detachment includes presenting the memento for detachment from the auxiliary label.

38. A wine bottle memento comprising:
a detachable memento having an interior surface affixed overlying an exterior surface of a wine bottle; and,
wherein the memento is used to subsequently identify the wine bottle.

39. The memento of claim 38 further comprising:
a label having an interior surface affixed to the exterior surface of the wine bottle; and,
wherein the memento is a detachable portion of the label.

40. The memento of claim 38 further comprising:
a label having an interior surface, affixed to the exterior surface of the wine bottle, and an exterior surface; and,
wherein the memento interior surface is affixed to the exterior surface of the label.

41. The memento of claim 40 further comprising:
an adhesive attached to the memento interior surface.

42. The memento of claim 40 further comprising:
an adhesive attached to the label exterior surface underlying the memento interior surface.

43. The memento of claim 40 wherein the label includes an exterior surface glossy attachment area; and,
wherein the memento interior surface is affixed to the label glossy attachment area.

44. The memento of claim 40 wherein the memento is the label.

45. The memento of claim 38 further comprising:
an adhesive attached to the memento interior surface.

46. The memento of claim 38 further comprising:
an adhesive attached to the bottle exterior surface underlying the memento interior surface.

47. The memento of claim 38 wherein the memento has an exterior surface with markings selected from the group including vintager, vintage, type of wine, type of grape, growing region, location of vintager, awards, price, barcode, reviews, coupons, and distributor.

48. The memento of claim 38 wherein the memento has an exterior surface with markings selected from the group including manufacturer, product name, sales promotion information, and lot number.

49. The memento of claim 38 further comprising:
a pull-tab handle for grasping when detaching the memento from the wine bottle.

50. The memento of claim 38 wherein the memento is made of paper.

51. The memento of claim 38 wherein the memento is made of a metallic foil.

52. The memento of claim 38 wherein the memento is a tag.

53. The memento of claim 52 wherein the memento tag includes an interior surface; and;
the memento further comprising:
an adhesive attaching at least a portion of the memento tag to a bottle exterior surface.

54. The memento of claim 53 further comprising:
a link selected from the group including string, ribbon, and elastic having a first end attached to the memento tag and a second end attached to a bottle exterior surface.

55. The memento of claim 52 wherein the memento tag is a semi-rigid material.
